(19) United States
(12) Patent Application Publication
(10) Pub. No.: US 2026/0368972 A1
(43) Pub. Date: Nov. 19, 2026

(54) ELECTRONIC DEVICE, METHOD, AND NON-TRANSITORY COMPUTER-READABLE RECORDING MEDIUM FOR MANAGING USER PROFILE

(71) Applicant: SAMSUNG ELECTRONICS CO., LTD., Suwon-si (KR)

(72) Inventors: Subin LEE, Suwon-si (KR); Jaeyung YEO, Suwon-si (KR); Seonmin AHN, Suwon-si (KR); Huncheol OH, Suwon-si (KR); Miyeoung CHUNG, Suwon-si (KR)

(73) Assignee: SAMSUNG ELECTRONICS CO., LTD., Suwon-si (KR)

(21) Appl. No.: 19/726,093

(22) Filed: Jun. 30, 2026

Related U.S. Application Data
(63) Continuation of application No. PCT/KR2024/018164, filed on Nov. 18, 2024.

(30) Foreign Application Priority Data
Jan. 12, 2024 (KR) 10-2024-0005426
Feb. 2, 2024 (KR) 10-2024-0016943

(51) Int. Cl. G06T 11/60; G06F 40/40

(52) U.S. Cl. CPC G06T 11/60; G06F 40/40; G06T 2200/24

(57) ABSTRACT

An electronic device including at least one processor including processing circuitry; and memory including one or more storage mediums storing instructions. The instructions, when executed by the at least one processor individually or collectively, cause the electronic device to: generate, based on a user profile, a prompt for processing an image; control, based on the prompt, a generative artificial intelligence (AI) model to process the image; and determine, based on a user input related to the processed image, whether to update the user profile.

### CROSS-REFERENCE TO RELATED APPLICATIONS

This application is a continuation of International Application No. PCT/KR2024/018164, filed on Nov. 18, 2024, which is based on and claims priority to Korean Patent Application No. 10-2024-0016943, filed on Feb. 2, 2024, in the Korean Ministry of Intellectual Property, and Korean Patent Application No. 10-2024-0005426, filed on Jan. 12, 2024, in the Korean Ministry of Intellectual Property, the disclosures of which are incorporated by reference herein in their entireties.

### BACKGROUND

### 1. Field

The disclosure relates to an electronic device, a method, and a non-transitory computer readable recording medium that manage a user profile.

### 2. Description of Related Art

Artificial intelligence is a field of computer engineering and information technology that studies methods for enabling a computer to perform thinking, learning, and self-development that may be performed by human intelligence. It means enabling the computer to imitate an intelligent behavior of a human.

The artificial intelligence is intended to simulate a neural activity of a person (or an organism), such as perception and/or inference, and may be implemented as hardware, software, or a combination thereof designed to perform a calculation for the simulation of a neural activity.

The artificial intelligence may generate new content (e.g., a text, an image, music, an audio, or a video) based on an indication. The artificial intelligence that generates new content according to an indication may be referred to as a generative artificial intelligence.

The above-described information may be provided as a related art for the purpose of helping understanding of the present disclosure. No claim or determination is raised as to whether any of the above-described descriptions may be applied as a prior art related to the present disclosure.

### SUMMARY

According to one or more embodiments of the disclosure, an electronic device including at least one processor including processing circuitry; and memory including one or more storage mediums storing instructions. The instructions, when executed by the at least one processor individually or collectively, cause the electronic device to: generate, based on a user profile, generate a prompt for processing an image; control, based on the prompt, control a generative artificial intelligence (AI) model to process the image; and determine, based on a user input related to the processed image, determine whether to update the user profile.

According to one or more embodiments of the disclosure, a method performed by an electronic device. The method including generating, based on a user profile, generating a prompt for processing an image; controlling, Jun. 29, 2026 based on the prompt, controlling a generative artificial intelligence (AI) model to process the image; and determining, based on a user input related to the processed image, determining whether to update the user profile.

A non-transitory computer readable storage medium is disclosed. The non-transitory computer readable storage medium may store a program including instructions. An electronic device may include at least one processor including processing circuitry. The electronic device may include memory including one or more storage mediums storing instructions. The instructions, when executed individually or collectively by the at least one processor including processing circuitry of the electronic device, may cause the electronic device to, based on a user profile, generate a prompt for processing an image. The instructions, when executed by the at least one processor individually or collectively, may cause the electronic device to, based on the prompt, control a generative artificial intelligence (AI) model to process the image. The instructions, when executed by the at least one processor individually or collectively, may cause the electronic device to, based on a user input related to the processed image, determine whether to update the user profile.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram of an electronic device in a network environment according to various embodiments;

FIG. 2A is a block diagram of an electronic device according to one or more embodiments of the disclosure;

FIG. 2B is a block diagram of a program of an electronic device according to one or more embodiments of the disclosure;

FIG. 3A illustrates an example of a prompt according to one or more embodiments of the disclosure;

FIG. 3B illustrates an example of an operation in which an electronic device processes an image according to a prompt, according to one or more embodiments of the disclosure;

FIG. 3C illustrates an example of an operation in which an electronic device processes an image according to a prompt, according to one or more embodiments of the disclosure;

FIG. 4A illustrates an example of a prompt, according to one or more embodiments of the disclosure;

FIG. 4B illustrates an example of an operation in which an electronic device processes an image according to a prompt, according to one or more embodiments of the disclosure;

FIG. 4C illustrates an example of an operation in which an electronic device processes an image according to a prompt, according to one or more embodiments of the disclosure;

FIG. 4D illustrates an example of an operation in which an electronic device displays a notification for a processed image, according to one or more embodiments of the disclosure;

FIG. 5A illustrates an example of a prompt according to one or more embodiments of the disclosure;

FIG. 5B illustrates an example of an operation in which an electronic device processes an image according to a prompt, according to one or more embodiments of the disclosure;

FIG. 5C illustrates an example of an operation in which an electronic device processes an image according to a prompt, according to one or more embodiments of the disclosure;

FIG. 6 illustrates an example of a prompt according to a change in a user profile, according to one or more embodiments of the disclosure;

FIG. 7 is a flowchart illustrating an operation of an electronic device according to one or more embodiments of the disclosure;

FIG. 8 is a flowchart illustrating an operation of an electronic device according to one or more embodiments of the disclosure;

FIG. 9 is a flowchart illustrating an operation of an electronic device according to one or more embodiments of the disclosure;

FIG. 10 is a flowchart illustrating an operation of an electronic device according to one or more embodiments of the disclosure;

FIG. 11 is a flowchart illustrating an operation of an electronic device according to one or more embodiments of the disclosure;

FIG. 12 is a flowchart illustrating an operation of an electronic device according to one or more embodiments of the disclosure;

FIG. 13 is a flowchart illustrating an operation of an electronic device according to one or more embodiments of the disclosure; and.

FIG. 14 is a diagram illustrating a structure of a generative AI model of an electronic device, according to one or more embodiments of the disclosure.

### DETAILED DESCRIPTION

Hereinafter, an embodiment of the present disclosure will be described in detail with reference to drawings such that those having ordinary knowledge in the art to which the present disclosure belongs may easily implement the present disclosure. However, the present disclosure may be implemented in various different forms and is not limited to the embodiment described herein. In association with a description of the drawings, the same or similar reference numerals may be used for the same or similar components. In addition, in the drawings and the associated descriptions, a description of well-known functions and configurations may be omitted for clarity and brevity.

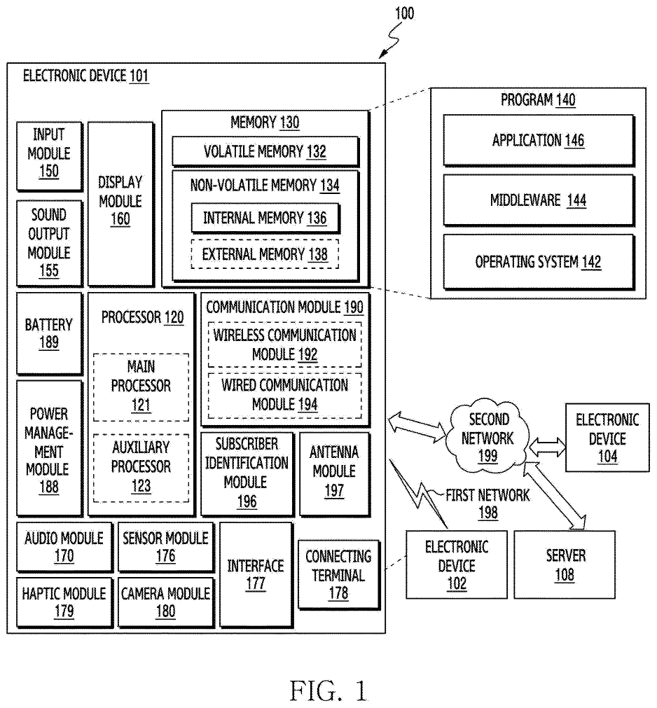

FIG. 1 is a block diagram illustrating an electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

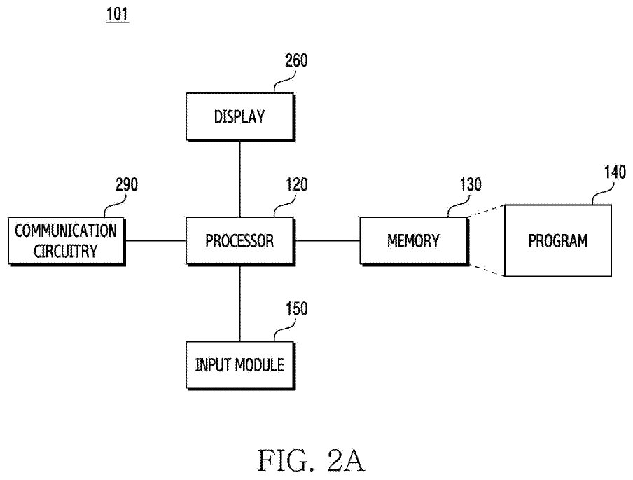

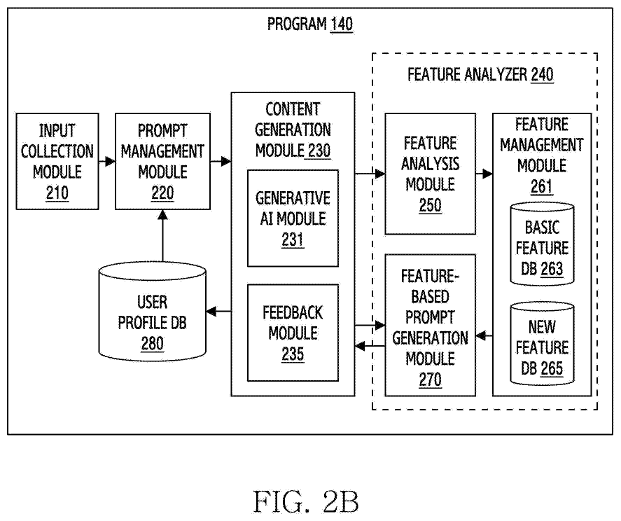

FIG. 2A is a block diagram of an electronic device according to one or more embodiments.

In one or more embodiments, an electronic device 101 of FIG. 2A may correspond to the electronic device 101 of FIG. 1. Referring to FIG. 2A, the electronic device 101 may include a processor 120, memory 130, an input module 150, a display 260, and communication circuitry 290.

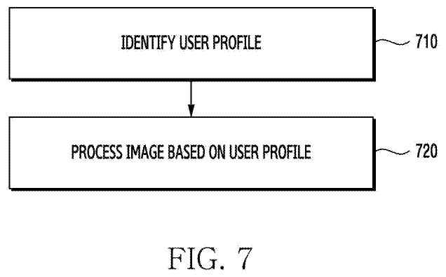

In one or more embodiments, the processor 120 may be used to execute operations of the electronic device 101 to be exemplified in descriptions of FIGS. 7, 8, 9, 10, 11, 12, and 13. The processor 120 may include at least a portion of the processor 120 of FIG. 1 or may correspond to at least a portion of the processor 120 of FIG. 1. The processor 120 may include one or more processors including an application processor (AP) and/or a communication processor (CP). The processor 120 may be implemented as a single chip such as a system on chip (SoC) or may also be implemented as a plurality of chips. The processor 120 may be implemented as one integrated circuit or may also be implemented as a plurality of integrated circuits. The processor 120 may also be arranged in a distributed manner in the electronic device 101.

In one or more embodiments, the memory 130 may (at least temporarily) store instructions for executing operations of the electronic device 101 to be exemplified in descriptions of FIGS. 7, 8, 9, 10, 11, 12, and 13. The instructions may be executed by the processor 120. The instructions may be included in one or more programs 140 stored in the memory 130. The memory 130 may include at least a portion of the memory 130 (or at least a portion of the non-volatile memory 134) of FIG. 1 or may correspond to the at least a portion of the memory 130 (or the at least a portion of the non-volatile memory 134) of FIG. 1. The memory 130 may include a main memory (e.g., a read only memory (ROM) or a random access memory (RAM)) in the electronic device 101, a register for the processor 120, a cache for the processor 120, a register for the communication circuitry 290, a buffer (or a soft buffer) for the communication circuitry 290, and/or an auxiliary memory (e.g., a hard disk drive (HDD) or a solid state drive (SSD)) of the electronic device 101. The memory 130 may be implemented as a single chip or may also be implemented as a plurality of chips. The memory 130 may be implemented as one integrated circuit or may also be implemented as a plurality of integrated circuits. The memory 130 may also be arranged in a distributed manner in the electronic device 101.

In one or more embodiments, the input module 150 may include at least one physical key (e.g., buttons) for obtaining a user input. The input module 150 may correspond to at least a portion of the input module 150 of FIG. 1.

In one or more embodiments, the display 260 may display visual content (e.g., an image). For example, the display 260 may include at least a portion of the display module 160 of FIG. 1, or may correspond to at least a portion of the display module 160 of FIG. 1.

In one or more embodiments, the communication circuitry 290 may be used for a communication connection between the electronic device 101 and another device (e.g., an electronic device 102, an electronic device 104, or a server 108). The communication circuitry 290 may include at least a portion of the communication module 190 (or the wireless communication module 192) of FIG. 1 or may correspond to the at least a portion of the communication module 190 (or the wireless communication module 192) of FIG. 1. The communication circuitry 290 may include communication circuitry for a long-distance communication network. The communication circuitry 290 may be used to establish a communication link. The communication circuitry 290 may be implemented as a single chip or may also be implemented as a plurality of chips. The communication circuitry 290 may be implemented as one integrated circuit or may also be implemented as a plurality of integrated circuits. The communication circuitry 290 may also be arranged in a distributed manner in the electronic device 101.

FIG. 2B is a block diagram of a program of an electronic device according to one or more embodiments.

FIG. 2B may be described with reference to FIGS. 1 and 2A.

Referring to FIG. 2B, the program 140 may include an input collection module 210, a prompt management module 220, a content generation module 230, a feature analyzer 240, and/or a user profile database (DB) 280. In one or more embodiments, the content generation module 230 may include a generative artificial intelligence (AI) module 231 and a feedback module 235. In one or more embodiments, the feature analyzer 240 may include a feature analysis module 250, a feature management module 261, and a feature-based prompt generation module 270. In one or more embodiments, the feature management module 261 may include a basic feature DB 263 and a new feature DB 265.

Hereinafter, operations in which the electronic device 101 generates a prompt, processes an image, and generates and/or updates a user profile will be described with reference to components of FIG. 2B.

### Generating a Prompt

In one or more embodiments, the prompt management module 220 may generate or identify a prompt based on a user input and/or the user profile DB 280. In one or more embodiments, the prompt management module 220 may generate or identify a prompt based on obtaining a user input requesting generation of an output image. In one or more embodiments, the prompt management module 220 may generate or identify a prompt based on the user profile DB 280 being updated. In one or more embodiments, the prompt may include data for guiding generation of an output image through the content generation module 230 or the generative AI module 231. In one or more embodiments, the prompt may be a task instruction for the generative AI module 231. In one or more embodiments, the prompt may be a set of words or a sentence for generating an output image from an input image through the generative AI module 231. In one or more embodiments, the prompt may be a set of words or a sentence for correcting or processing an input image through the generative AI module 231. The correction (or processing) of an image may include application of an image filter (e.g., Warm, Calm, Lolly, Winter, Pink Rose, Ivory, Faded, Soft, Kiss Me, Black and White, Cinematic, Loof, Shadow, Monstera, Palm Tree, Vignetting, Blur, and/or Bokeh) to the image. In one or more embodiments, the correction of an image may include adjustment of a color tone (e.g., a light balance, brightness, exposure, contrast, highlight, shadow, saturation, tint, color temperature, sharpness, and/or clarity) of the image. In one or more embodiments, the correction of an image may include application of a deco (or a decoration) (e.g., drawing, a sticker, and/or a text) of the image. In one or more embodiments, the prompt may be a context (e.g., information on an object (or a character) (or a sticker) to be included in an output image, and/or information on a position of the object) inputted to the generative AI module 231.

In one or more embodiments, the prompt management module 220 may identify at least one user profile corresponding to an input image among one or more user profiles stored in the user profile DB 280. In one or more embodiments, the prompt management module 220 may identify at least one user profile corresponding to a type of an input image and/or a situation (hereinafter, a situation of an input image) in which an input image is obtained, captured, or described in the user profile DB 280 The type of an input image may be distinguished according to a method (e.g., landscape, portrait, or still life) that an object included in the input image is described. The type of an input image may be distinguished according to a purpose (e.g., a background screen, a lock screen (e.g., a wallpaper), uploading or sharing of a social network service (SNS) application) of the image. The situation of an input image may be distinguished according to a type (e.g., a person, an animal, a plant, or an item) of objects included in the input image, a relationship (e.g., a friend or family) between the objects, and/or a time (e.g., morning, forenoon, afternoon, evening, or dawn). However, it is not limited thereto. In one or more embodiments, the prompt management module 220 may identify at least one updated user profile among one or more user profiles stored in the user profile DB 280.

In one or more embodiments, the prompt management module 220 may generate or identify a prompt based on at least one user profile corresponding to the input image. However, it is not limited thereto. In one or more embodiments, the prompt management module 220 may generate or identify a prompt based on at least one updated user profile among one or more user profiles stored in the user profile DB 280.

In one or more embodiments, the prompt management module 220 may generate or identify a prompt based on a user input. For example, the prompt management module 220 may generate or identify a prompt based on a user input for changing (or modifying) a presented (or displayed through the display 260) prompt (e.g., a prompt generated based on a user profile). For example, the prompt management module 220 may generate or identify a prompt based on a user input to input a sentence for guiding generation of an output image without a prompt generated based on a user profile.

In one or more embodiments, the prompt management module 220 may output (e.g., display) a prompt based on the user profile DB 280 through the display 260. In one or more embodiments, the prompt management module 220 may change a prompt based on the user profile DB 280 based on a user input. In one or more embodiments, the user input may include a touch input to an outputted (or displayed) prompt and/or an input through the input module 150. However, it is not limited thereto.

### Image Processing

In one or more embodiments, the content generation module 230 may generate an output image using the generative AI module 231. In one or more embodiments, the content generation module 230 may generate an output image by inputting a prompt to the generative AI module 231. In one or more embodiments, the content generation module 230 may generate an output image by inputting a prompt and an input image to the generative AI module 231. In one or more embodiments, the output image may be an image in which an input image has been processed (e.g., corrected). In one or more embodiments, the processing (e.g., correction) of an input image may include application of an image filter, adjustment of a color tone, and/or application of a deco to the input image. However, it is not limited thereto. In one or more embodiments, the content generation module 230 may generate an output image by inputting only a prompt to the generative AI module 231 without an input image.

In one or more embodiments, the generative AI module 231 may include a pre-trained AI model. In one or more embodiments, the generative AI module 231 may include a plurality of parameters related to a neural network having a structure based on an encoder and a decoder, such as a transformer. In one or more embodiments, the generative AI module 231 may include a bi-directional model (e.g., bidirectional encoder representations from transformers (BERT)) based on training for an encoder, or an auto-encoding model (e.g., a diffusion model). In one or more embodiments, the generative AI module 231 may include an auto-regressor model (e.g., a generative pre-trained transformer (GPT)) based on training for a decoder. In one or more embodiments, the generative AI module 231 may include a sequence-to-sequence model (e.g., stable diffusion, DALL-E 2) based on training for encoders and decoders. In one or more embodiments, the generative AI module 231 may include a large language model (LLM) for processing natural language based on massive parameters. However, it is not limited thereto. In one or more embodiments, the generative AI module 231 may include parameters for driving a neural network such as a convolutional neural network (CNN), a recurrent neural network (RNN), a feedforward neural network (FNN), and/or a long short-term memory (LSTM).

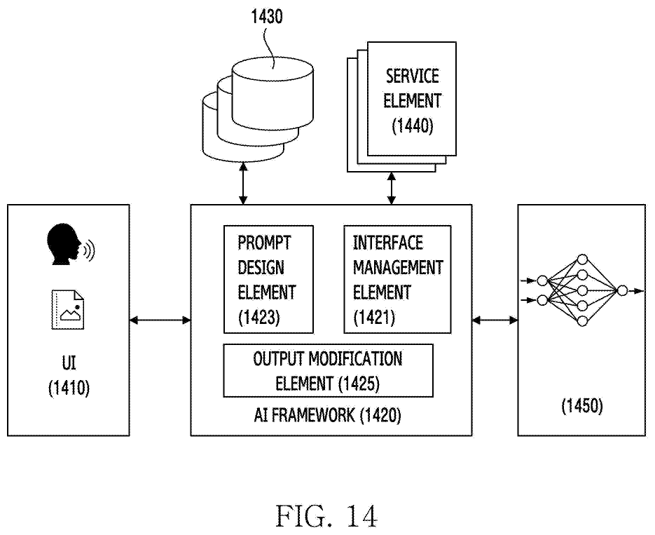

In one or more embodiments, the generative AI module 231 may correspond to a generative AI model 1450 of FIG. 14.

In one or more embodiments, the content generation module 230 may generate an image based on a prompt generated based on obtaining a user input requesting generation of an output image. However, it is not limited thereto. In one or more embodiments, the content generation module 230 may generate an image based on a prompt generated based on the user profile updated in the user profile DB 280.

In one or more embodiments, the content generation module 230 may output (e.g., display) a generated output image through the display 260. In one or more embodiments, the content generation module 230 may output (e.g., display), through the display 260, an output image in response to the output image being generated through a prompt based on a user input. In one or more embodiments, the content generation module 230 may output (e.g., display) an output image on a screen of an application in which a user input for a prompt is obtained. In one or more embodiments, the content generation module 230 may output (e.g., display), through the display 260, an output image in response to the output image being generated through a prompt generated through the updated user profile. In one or more embodiments, the content generation module 230 may output (e.g., display) a notification indicating the generation of an output image through a notification bar.

### Generating and/or Updating a User Profile

In one or more embodiments, the feature analysis module 250 may identify and/or extract one or more features from a prompt for an output image and/or the output image. In one or more embodiments, the feature analysis module 250 may identify and/or extract one or more features from a prompt for an output image and/or the output image according to a type of the output image, a situation (hereinafter, a situation of the output image) described by the output image, and/or correction (e.g., an applied image filter, an applied color tone, and/or an applied deco) applied to the output image. The type of an output image may be distinguished according to a method (e.g., landscape, portrait, or still life) that an object included in the output image is described, and/or a design pattern. The type of an output image may be distinguished according to a purpose (e.g., a background screen, a lock screen (e.g., a wallpaper), uploading or sharing of an SNS application) of the output image. The situation of an output image may be distinguished according to a type (e.g., a person, an animal, a plant, or an item) of objects included in the output image, a relationship (e.g., a friend or family) between the objects, and/or a time (e.g., morning, forenoon, afternoon, evening, or dawn). In one or more embodiments, in a case that an image filter is applied to an output image, the feature analysis module 250 may identify and/or extract features (e.g., a word (e.g., clear, natural, warm, cold, and/or blur, bokeh) describing a type of an image filter) related to the applied image filter. In one or embodiments, in a case that a specific color tone is applied to an output image, the feature analysis module 250 may identify and/or or extract features (e.g., a word (e.g., a light balance, brightness, or exposure) describing a color tone) related to the applied specific color tone. In one or more embodiments, in a case that a specific deco is applied to an output image, the feature analysis module 250 may identify and/or extract features (e.g., a word (e.g., a name of a sticker (or a character)) describing a deco) related to the applied specific deco. In one or more embodiments, in a case that an output image is used as a wallpaper, the feature analysis module 250 may identify and/or extract features related to a pattern design, an illustration, and a description method (e.g., a person or a landscape) of the output image. In one or more embodiments, in a case that a character is included in an output image, the feature analysis module 250 may identify and/or extract features (e.g., a word (e.g., cute or funny) describing a shape of the character, and/or a type (e.g., a rabbit) of the character) related to the character.

In one or more embodiments, the feature management module 261 may store one or more features (or words representing the features) extracted from the feature analysis module 250 in the basic feature DB 263 and/or the new feature DB 265. In one or more embodiments, the feature management module 261 may store one or more features (or words representing the features) in the basic feature DB 263 and/or the new feature DB 265 according to a type and/or a situation of the output image. In one or more embodiments, in a case that a type and/or a situation of the image from which a feature is extracted is different, substantially the same features (or words representing the features) may be stored in different locations (e.g., the basic feature DB 263 or the new feature DB 265). In one or more embodiments, a character-related feature (e.g., a rabbit sticker) extracted from a landscape image may be stored in the new feature DB 265, and a character-related feature (e.g., a rabbit sticker) extracted from an image including friends may be stored in the basic feature DB 263. However, it is not limited thereto.

In one or more embodiments, the feature management module 261 may store one or more features (or words) in the basic feature DB 263 and/or the new feature DB 265 based on similarity with basic features (or words) stored in the basic feature DB 263. In one or more embodiments, in a case that a feature extracted from an output image has similarity more than or equal to reference similarity with the basic features included in the basic feature DB 263, the feature management module 261 may store the feature extracted from the output image in the basic feature DB 263. In one or more embodiments, in a case that a feature extracted from an output image has similarity less than reference similarity with the basic features included in the basic feature DB 263, the feature management module 261 may store the feature extracted from the output image in the new feature DB 265. Herein, the similarity may be similarity between meanings of each of features. For example, the similarity may be calculated based on a distance between vectors assigned to each of the meanings. However, it is not limited thereto. For example, a feature ‘clear’ and a feature ‘clean’ may be classified into features having a similar meaning. For example, in a case that the feature ‘clean’ is newly extracted from an output image in a state that the feature ‘clear’ is stored in the basic feature DB 263, the feature management module 261 may store the feature ‘clean’ in the basic feature DB 263. For example, the feature ‘clear’ and a feature ‘calm’ may be classified into features having no similar meaning. For example, in a case that the feature ‘calm’ is newly extracted from an output image in a state that the feature ‘clear’ is stored in the basic feature DB 263, the feature management module 261 may store the feature ‘calm’ in the new feature DB 265. However, it is not limited thereto.

In one or more embodiments, the feature management module 261 may store a feature stored in the new feature DB 265 in the basic feature DB 263 based on the number of times the feature stored in the new feature DB 265 is extracted from an image. In one or more embodiments, the feature management module 261 may store a feature stored in the new feature DB 265 in the basic feature DB 263 based on the number of times the feature stored in the new feature DB 265 is extracted from an image exceeding a threshold number. In one or more embodiments, the feature management module 261 may store features of a type that is substantially the same as (or similar to) a feature newly stored in the basic feature DB 263, in the basic feature DB 263, based on the feature stored in the new feature DB 265 being stored in the basic feature DB 263. In one or more embodiments, a type of a feature being substantially the same (or similar) may indicate that a type of image correction related to the feature is substantially the same (or similar). For example, the type of image correction may include an image filter, a color tone, and/or a deco. For example, in a case that two or more features are related to an image filter, the two or more features may be evaluated as having substantially the same (or similar) type. For example, in a case that two or more features are related to a color tone, the two or more features may be evaluated as having substantially the same (or similar) type. For example, in a case that two or more features are related to a deco, the two or more features may be evaluated as having substantially the same (or similar) type. However, it is not limited thereto. In one or more embodiments, a type of a feature being substantially the same (or similar) may mean that features related to image corrections that are not simultaneously applied to an image related to the substantially same (or similar) feature may be evaluated as having substantially the same (or similar) type. For example, since two or more color tones may be applied to an image, features related to different color tones may be evaluated as having different types. For example, a feature related to a light balance may be evaluated as a different type of feature from a feature related to brightness.

In one or more embodiments, the feature-based prompt generation module 270 may generate a prompt based on features (or words) stored in the basic feature DB 263 and/or the new feature DB 265. A prompt may be generated by combining some of one or more features included in the basic feature DB 263 and some of one or more features included in the new feature DB 265. In one or more embodiments, a ratio between some features selected in the basic feature DB 263 and some features selected in the new feature DB 265 may be adjusted according to setting of a user.

In one or more embodiments, the content generation module 230 may generate a new image based on a prompt generated by the feature-based prompt generation module 270. In one or more embodiments, the feature-based prompt generation module 270 may determine whether to modify a prompt and/or update a user profile based on a user input to an output image obtained through the feedback module 235.

In one or more embodiments, in a case that the user input to the output image is negative feedback (e.g., deleting an image or requesting modification to an image), the feature-based prompt generation module 270 may newly select some of features stored in the basic feature DB 263 and/or the new feature DB 265 according to a set ratio. In one or more embodiments, the feature-based prompt generation module 270 may generate a prompt based on the newly selected features.

In one or more embodiments, in a case that the user input to the output image is positive feedback (e.g., storing an image, uploading or sharing an image, or favorite (or, like)), the feature-based prompt generation module 270 may update the user profile DB 280 based on the prompt inputted to generate an image.

In one or more embodiments, the user profile DB 280 may store a user profile. In one or more embodiments, the user profile stored in the user profile DB 280 may be different according to a type of an image and/or a situation of the image. For example, the type of an image may be distinguished according to a method (e.g., landscape, portrait, or still life) that describes an object included in the image. For example, the situation of an image may be distinguished according to a type (e.g., a person, an animal, a plant, or an item) of objects included in the image, a relationship (e.g., a friend or family) between the objects, and/or a time (e.g., morning, forenoon, afternoon, evening, or dawn). For example, the situation of an image may be distinguished according to a situation in which the objects included in the image are friends or family. For example, the user profile may be a profile for generating a prompt to attach a designated character sticker in a case that the objects included in the image are friends. However, it is not limited thereto.

As described above, the basic feature DB 263 and/or the new feature DB 265 have been exemplified as being updated based on features included in an output image through an image outputted through the generative AI module 231, but it is merely an example. According to one or more embodiments, the basic feature DB 263 and/or the new feature DB 265 may be updated based on an activity of the user obtained (or identified) through the input collection module 210.

In one or more embodiments, the input collection module 210 may collect a user input through a designated application. In one or more embodiments, the designated application may be an application (e.g., a gallery application, an SNS application, or a camera application) related to designated content (e.g., an image). In one or more embodiments, the designated content may be content for analyzing a preference of the user (or for generating a profile). Hereinafter, the content may be exemplified as being an image. However, it is not limited thereto.

In one or more embodiments, the input collection module 210 may identify a user input for analyzing a preference of the user (or for generating a user profile), among user inputs related to the designated application. For example, the input collection module 210 may identify a user input for an image among user inputs related to the designated application. The input collection module 210 may identify a user input to an image displayed through the designated application. The image displayed through the designated application may include a gallery image, a profile image, a wallpaper, a background screen, an emoticon, and/or a character. In one or more embodiments, the user input to an image may include an input for correcting (or processing) the image. In one or more embodiments, the correction (or processing) of an image may include application of an image filter to the image. In one or more embodiments, the correction of an image may include adjustment of a color tone of the image. In one or more embodiments, the correction of an image may include application of a deco of the image.

In one or more embodiments, the feature analysis module 250 may identify and/or extract one or more features from content related to a user activity based on the user activity identified through the input collection module 210. In one or more embodiments, the feature management module 261 may store the one or more features (or words representing the features) extracted from content related to a user activity in the basic feature DB 263 and/or the new feature DB 265. In one or more embodiments, the feature-based prompt generation module 270 may generate a prompt based on features (or words) stored in the basic feature DB 263 and/or the new feature DB 265. In one or more embodiments, the content generation module 230 may generate a new image based on a prompt generated by the feature-based prompt generation module 270. In one or more embodiments, the feature-based prompt generation module 270 may update a user profile based on a user input to an output image obtained through the feedback module 235.

The electronic device 101 as described above may analyze (or identify) a preference, of the user, for an image. In one or more embodiments, the electronic device 101 may present a prompt to the user for correcting an image according to a preference of the user. Accordingly, the number of times of an input for changing a prompt requested to the user may be decreased.

In addition, the electronic device 101 may update a user profile as a preference of the user is changed. Accordingly, the electronic device 101 may provide the user with a prompt suitable for a preference of the user using the updated user profile.

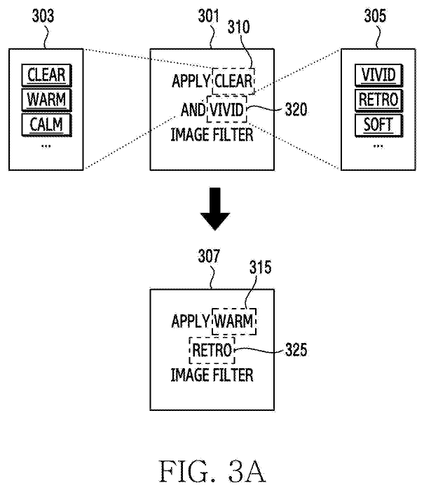

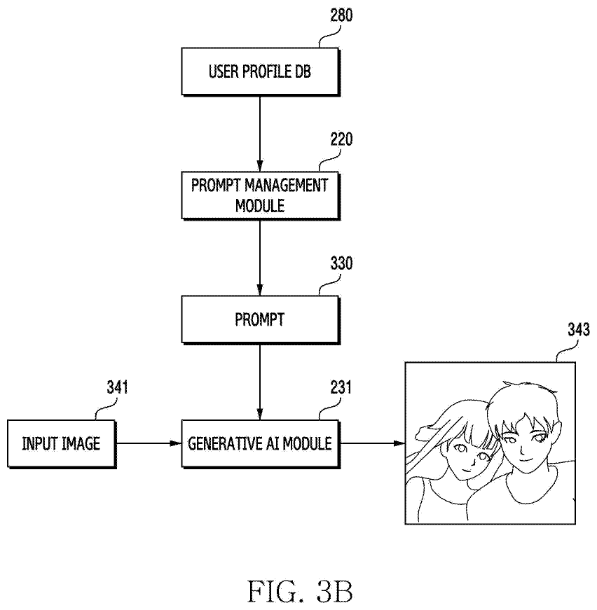

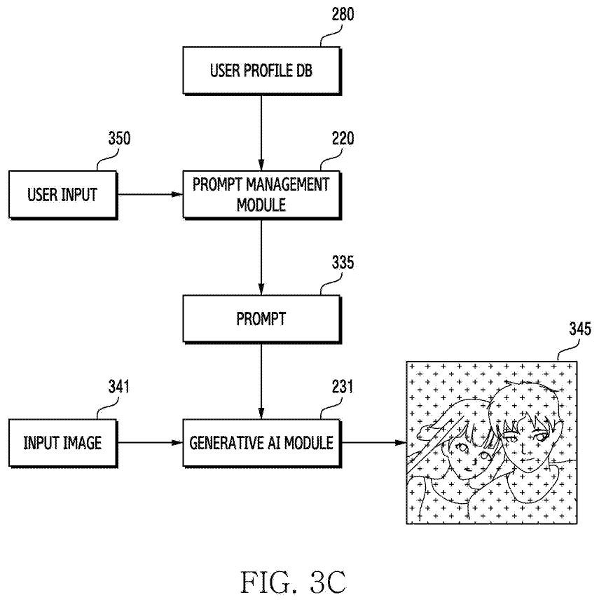

FIG. 3A illustrates an example of a prompt according to one or more embodiments. FIG. 3B illustrates an example of an operation in which an electronic device processes an image according to a prompt, according to one or more embodiments. FIG. 3C illustrates an example of an operation in which an electronic device processes an image according to a prompt, according to one or more embodiments.

FIGS. 3A, 3B, and 3C may be described with reference to FIGS. 1, 2A, or 2B.

FIG. 3A may exemplify a situation in which a prompt management module 220 outputs a prompt (e.g., Apply a clear and vivid image filter). Referring to FIG. 3A, the prompt management module 220 may generate a prompt based on a request (or a user input) for image correction. For example, the prompt management module 220 may generate a prompt based on a user profile corresponding to a type of an input image and/or a situation of the input image. In one or more embodiments, the prompt management module 220 may display a screen 301 including the generated prompt through a display 260.

In one or more embodiments, the prompt management module 220 may obtain a user input for changing (or modifying) a prompt on the screen 301. The prompt management module 220 may display, through the display 260, a menu 303 that includes words (e.g., clear, warm, and calm) that may replace a word 310 based on a user input of selecting the word 310 (e.g., clear). For example, the prompt management module 220 may display, through the display 260, a menu 305 that includes words (e.g., clear, retro, and soft) that may replace a word 320 based on a user input of selecting the word 320 (e.g., clear). For example, the prompt management module 220 may change at least a portion of words included in the prompt through a user input to the menus 303 and 305. For example, the prompt management module 220 may display a screen 307 including a prompt including words 315 and 325 (e.g., warm and retro) through the display 260 based on a user input. In one or more embodiments, the words included in the menus 303 and 305 may be words (or candidate words) that a user frequently uses (or prefers) according to a preference of the user. For example, the words included in the menu 303 may be words (or candidate words) that the user frequently uses (or prefers) according to a preference of the user in the same (or similar) type (e.g., a type of image correction) as the word 310 (e.g., clear and). For example, the words included in the menu 305 may be words that the user frequently uses (or prefers) according to a preference of the user in the same (or similar) type (e.g., a type of image correction) as the word 320 (e.g., clear). In one or more embodiments, the words included in the menus 303 and 305 may be included in the menus 303 and 305 according to a frequently used (or preferred) order. In one or more embodiments, the user frequently using (or preferring) the word may refer to a word being selected by a user input for modifying a prompt for a specific period before updating a preference of the user.

In one or more embodiments, some of the words included in the menus 303 and 305 may be a word included according to a previous preference of the user (or a user profile before the current user profile). In one or more embodiments, the prompt management module 220 may represent the words included in the menus 303 and 305 differently from each other. For example, the prompt management module 220 may blur and display a word included according to a previous preference (or words according to a previous basic feature), among the words included in the menus 303 and 305. For example, the prompt management module 220 may more vividly display a word that has been frequently used (or preferred) recently (or words according to a new feature), among the words included in the menus 303 and 305. Herein, the word according to a previous basic feature may be a word included in a previous (or pre-update) basic feature and not in a current (or post-update) basic feature.

In one or more embodiments, as the prompt is changed, an output image generated by a generative AI module 231 may be changed.

For example, referring to FIG. 3B, the generative AI module 231 may generate an output image 343 based on a prompt 330 (e.g., “Apply a clear and vivid image filter”) generated based on a user profile DB 280. In one or more embodiments, the generative AI module 231 may generate the output image 343 based on an input image 341 and the prompt 330 (e.g., “Apply a clear and vivid image filter”).

Referring to FIG. 3C, the generative AI module 231 may generate an output image 345 based on a prompt 335 (e.g., “Apply a warm retro image filter”) generated based on a user input 350. The user input 350 may be an input for changing the prompt 330 (e.g., “Apply a clear and vivid image filter”). The user input 350 may be a user input for changing the word 310 (e.g., clear and) included in the prompt 330 to the word 315 (e.g., warm). The user input 350 may be a user input for changing the word 320 (e.g., vivid) included in the prompt 330 to the word 325 (e.g., retro). In one or more embodiments, the generative AI module 231 may generate the output image 345 based on the input image 341 and the prompt 335 (e.g., “Apply a warm retro image filter”).

Thereafter, a feature analyzer 240 may store one or more features included in the output image 345 generated based on the prompt 335 in a basic feature DB 263 and/or a new feature DB 265. In one or more embodiments, the feature analyzer 240 may update the user profile in a case that the number of times a new feature is extracted by the changed prompt 335 and/or output image 345 exceeds a threshold number. For example, in a case that the number of times a feature related to “retro” is extracted exceeds a threshold number, the feature analyzer 240 may change a storage location of the feature related to “retro” from the new feature DB 265 to the basic feature DB 263. Thereafter, in a case that correction of another input image having substantially the same type and/or situation as the input image 341 is requested, the prompt management module 220 may generate a prompt of “Apply a warm retro image filter” other than “Apply a clear and vivid image filter”. Thereafter, a content generation module 230 may generate a new image based on a prompt generated by a feature-based prompt generation module 270. In one or more embodiments, the feature-based prompt generation module 270 may determine whether to modify a prompt and/or update a user profile based on a user input to an output image obtained through a feedback module 235. In one or more embodiments, in a case that the user input to the output image is positive feedback (e.g., storing an image, or uploading or sharing an image), the feature-based prompt generation module 270 may update the user profile DB 280 based on a prompt inputted to generate an image.

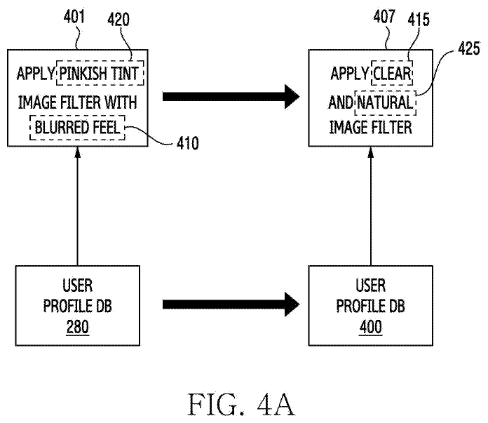

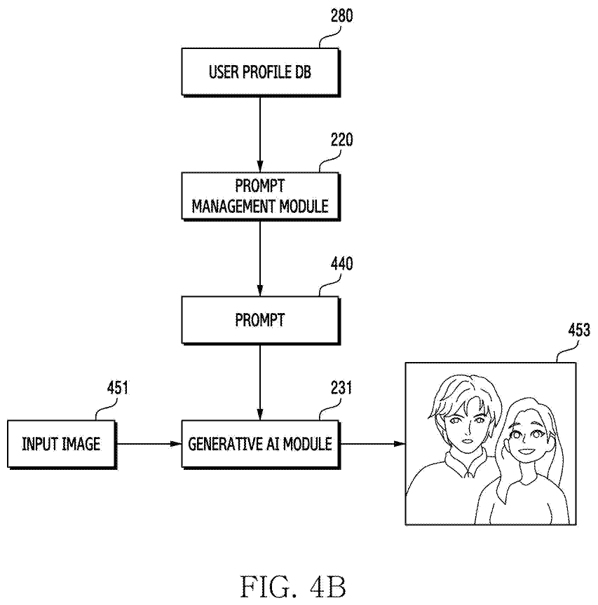

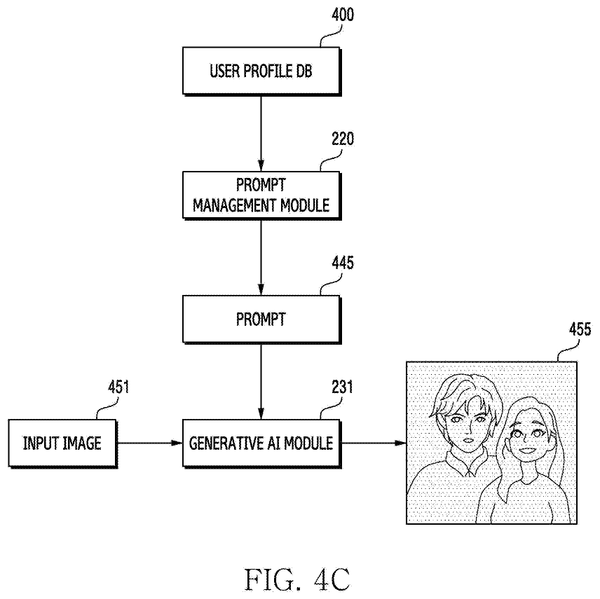

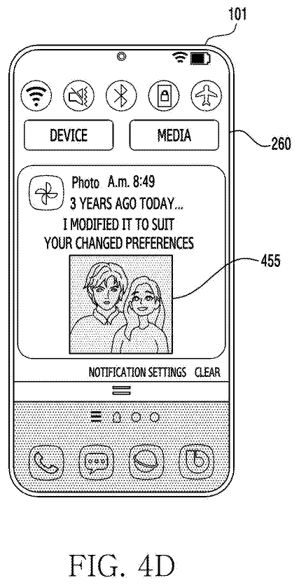

FIG. 4A illustrates an example of a prompt, according to one or more embodiments. FIG. 4B illustrates an example of an operation in which an electronic device processes an image according to a prompt, according to one or more embodiments. FIG. 4C illustrates an example of an operation in which an electronic device processes an image according to a prompt, according to one or more embodiments. FIG. 4D illustrates an example of an operation in which an electronic device displays a notification for a processed image, according to one or more embodiments.

FIGS. 4A, 4B, 4C, and 4D may be described with reference to FIGS. 1, 2A, or 2B.

In one or more embodiments, an electronic device 101 may display an output image newly generated according to a changed preference of a user on a display 260. For example, the electronic device 101 may change an output image based on an existing user profile to an output image based on a new user profile, based on the user profile being changed according to a preference change of the user. For example, the electronic device 101 may display an output image based on a new user profile on the display 260. For example, as a user profile for a type of a specific image and/or a situation of the image is changed, a prompt may be changed. For example, referring to FIG. 4A, a prompt 401 (e.g., Apply a pinkish tint image filter with a blurred feel) based on a pre-update user profile DB 280 may be changed to a prompt 407 (e.g., Apply a clear and natural image filter) based on a post-update user profile DB 400. The post-update user profile DB 400 may be a DB in which at least one user profile is changed among a plurality of user profiles included in the pre-update user profile DB 280.

Referring to FIG. 4A, as the user profile DB 280 is updated, a prompt generated by a feature management module 261 may be changed. For example, according to the update of the user profile DB 280, a word 410 (e.g., a blurred feel) included in the prompt 401 may be changed to a word 415 (e.g., clear and). For example, according to the update of the user profile DB 280, a word 420 (e.g., a pinkish tint) included in the prompt 401 may be changed to a word 425 (e.g., natural).

For example, referring to FIG. 4B, an output image 453 may be an image generated based on a prompt 440 (e.g., “Apply a pinkish tint image filter with a blurred feel”) generated based on the pre-update user profile DB 280. In one or more embodiments, the output image 453 may be an image generated based on an input image 451 and the prompt 440.

For example, referring to FIG. 4C, an output image 455 may be an image generated based on a prompt 445 (e.g., “Apply a clear and natural image filter”) generated based on the post-update user profile DB 400. In one or more embodiments, the output image 455 may be an image generated based on an input image 451 and the prompt 445.

In one or more embodiments, the electronic device 101 may update (or re-process) the output image 453, which was image-corrected (or processed) in the past, to the output image 445 based on the newly updated user profile DB 400 according to the update of the user profile DB 280. For example, referring to FIG. 4D, the electronic device 101 may display the output image 445 based on the updated user profile DB 400 on the display 260.

By re-correcting the image corrected according to the user's past preference according to a current preference, the electronic device 101 as described above may reflect the user's changing preference in the corrected images. In addition, the electronic device 101 may enable the user to recall past pictures by re-correcting the image corrected according to the user's past preference according to a current preference and then displaying it through the display 260.

The electronic device 101 as described above exemplifies updating the output image 453 image-corrected (or processed) through the past user profile DB 280 to the output image 445 based on the newly updated user profile DB 400, but it is merely an example. In one or more embodiments, the electronic device 101 may update (or re-process) the output image 445 based on the newly updated user profile DB 400 to the output image 453 image-corrected (or processed) through the past user profile DB 280. Accordingly, by re-correcting the image corrected according to a user's current preference according to the past preference, the electronic device 101 may enable the user to recall the past preference.

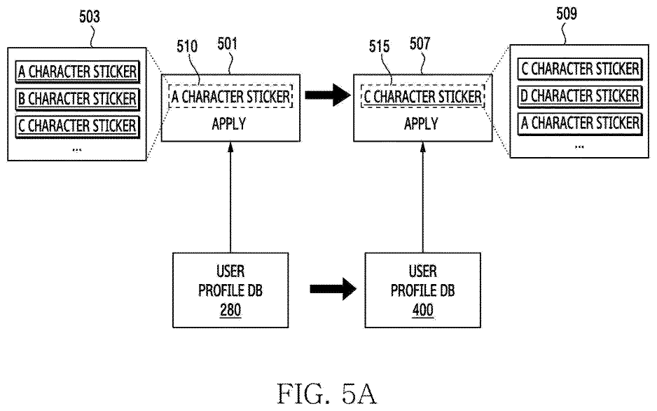

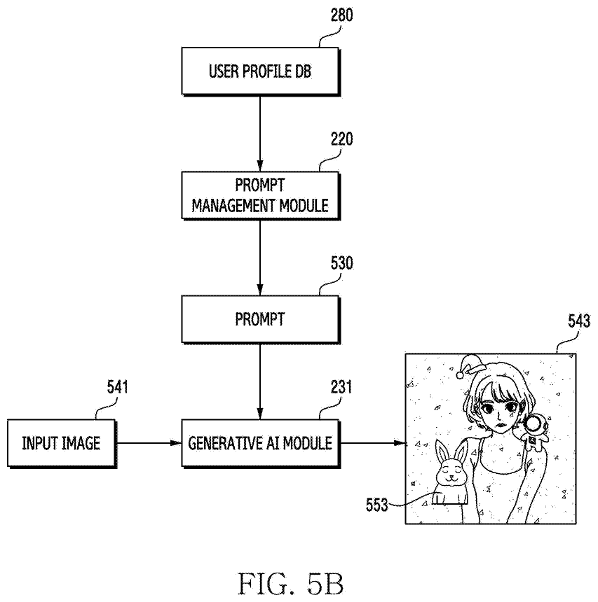

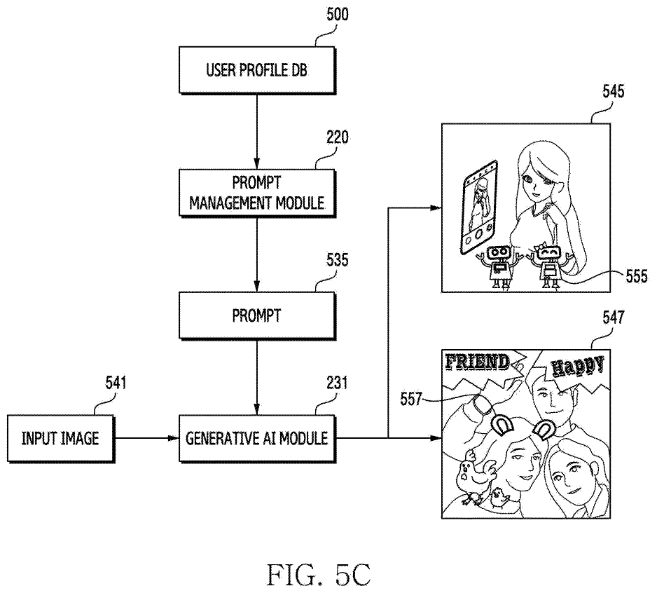

FIG. 5A illustrates an example of a prompt according to one or more embodiments. FIG. 5B illustrates an example of an operation in which an electronic device processes an image according to a prompt, according to one or more embodiments. FIG. 5C illustrates an example of an operation in which an electronic device processes an image according to a prompt, according to one or more embodiments.

FIGS. 5A, 5B, and 5C may be described with reference to FIGS. 1, 2A, or 2B.

In one or more embodiments, a prompt management module 220 may display a prompt generated according to a preference of a user on a display 260. In one or more embodiments, as a user profile for a type of a specific image and/or a situation of the image is changed, a prompt may be changed. For example, referring to FIG. 5A, a prompt 501 (e.g., Apply an A character sticker) based on a pre-update user profile DB 280 may be changed to a prompt 507 (e.g., Apply a C character sticker) based on a post-update user profile DB 400.

Referring to FIG. 5A, as the pre-update user profile DB 280 is updated to the user profile DB 400, a menu for updating a word of a prompt may also be changed. In one or more embodiments, the prompt management module 220 may display, through the display 260, a menu 503 that includes a list of character stickers that may replace an A character sticker 510 based on a user input for changing the prompt 501 (e.g., Apply an A character sticker) based on the pre-update user profile DB 280. The prompt management module 220 may display, through the display 260, a menu 509 that includes a list of character stickers that may replace a C character sticker 515 based on a user input for changing the prompt 507 (e.g., Apply a C character sticker) based on the post-update user profile DB 400.

Referring to FIG. 5B, an output image 543 may be an image generated based on a prompt 530 (e.g., “Apply an A character sticker”) generated based on the pre-update user profile DB 280. In one or more embodiments, the output image 543 may be an image generated based on an input image 541 and the prompt 530. In one or more embodiments, an A character sticker 553 may be attached to the output image 543.

For example, referring to FIG. 5C, output images 545 and 547 may be an image generated based on a prompt 535 (e.g., “Apply a C character sticker”) generated based on the post-update user profile DB 400. In one or more embodiments, the output images 545 and 547 may be an image generated based on the input image 541 and the prompt 535. In one or more embodiments, a C character sticker 555 or 557 may be attached to the output images 545 and 547.

The electronic device 101 as described above may generate a prompt for a deco attached according to a change in a preference of the user according to a current preference. Accordingly, the electronic device 101 may generate a prompt reflecting a changing preference of the user.

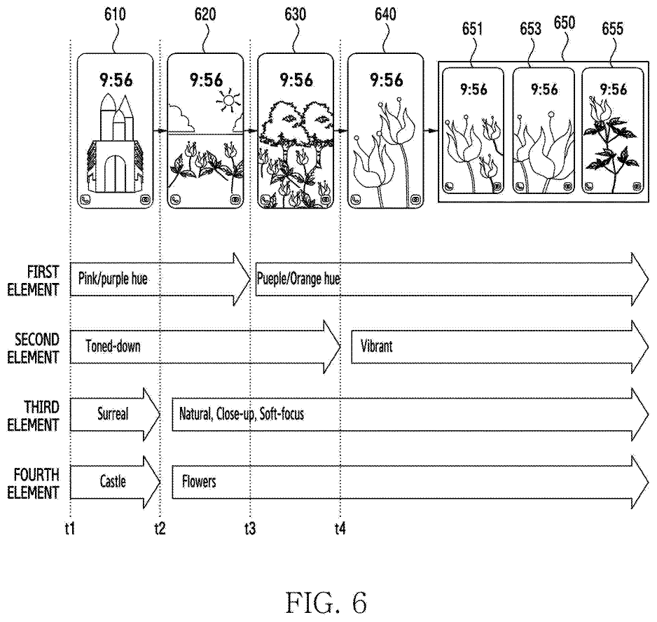

FIG. 6 illustrates an example of a prompt according to a change in a user profile, according to one or more embodiments.

FIG. 6 may be described with reference to FIGS. 1, 2A, or 2B.

In one or more embodiments, a prompt management module 220 may generate a prompt based on a user input requesting generation of a wallpaper. In one or more embodiments, the prompt management module 220 may generate a prompt for generating a wallpaper based on a user profile for generating a wallpaper.

In one or more embodiments, referring to FIG. 6, the prompt management module 220 may generate a prompt combining “pink/purple hue,” “toned-down,” “surreal,” and “castle” based on a user input requesting generation of a wallpaper between a time point t1 and a time point t2. In one or more embodiments, a generative AI module 231 may generate an image 610 based on a prompt generated between the time point t1 and the time point t2.

After the time point t2, the user profile may be updated. After the time point t2, as the user profile is updated, at least one element (e.g., a third element and a fourth element) of a plurality of elements related to the generation of a wallpaper may be changed. For example, a feature (or a word) related to the third element (e.g., a preferred composition) may be changed from surreal to natural, close-up, and soft-focus. For example, a feature (or a word) related to the fourth element (e.g., a preferred object) may be changed from castle to flowers. In one or more embodiments, the prompt management module 220 may generate a prompt combining “pink/purple hue”, “toned-down”, “natural, close-up, soft-focus”, and “flowers” based on a user input requesting generation of a wallpaper between the time point t2 and a time point t3. In one or more embodiments, the generative AI module 231 may generate an image 620 based on a prompt generated between the time point t2 and the time point t3.

After the time point t3, the user profile may be updated. After the time point t3, as the user profile is updated, at least one element (e.g., a first element) of a plurality of elements related to the generation of a wallpaper may be changed. For example, a feature (or a word) related to the first element (e.g., a preferred color) may be changed from pink/purple hue to pink/orange hue. In one or more embodiments, the prompt management module 220 may generate a prompt combining “pink/orange hue”, “toned-down”, “natural, close-up, soft-focus”, and “flowers” based on a user input requesting generation of a wallpaper between the time point t3 and a time point t4. In one or more embodiments, the generative AI module 231 may generate an image 630 based on a prompt generated between the time point t3 and the time point t4.

After the time point t4, the user profile may be updated. After the time point t4, as the user profile is updated, at least one element (e.g., a second element) of a plurality of elements related to the generation of a wallpaper may be changed. For example, a feature (or word) related to the second element (e.g., a preferred color sense) may be changed from toned-down to vibrant. In one or more embodiments, the prompt management module 220 may generate a prompt combining “pink/orange hue”, “vibrant”, “natural, close-up, soft-focus”, and “flowers” based on a user input requesting generation of a wallpaper after the time point t4. In one or more embodiments, the generative AI module 231 may generate images 640 and 650 based on a prompt generated after the time point t4. For example, the generative AI module 231 may generate the single image 640 or generate the dynamic image 650 in which a plurality of images 651, 653, and 655 are sequentially changed. For example, the generative AI module 231 may generate the dynamic image 650 in which the plurality of images 651, 653, and 655 are sequentially changed in a case that feedback of the user on the image 640 is positive (e.g., favorite (or, like)).

FIG. 7 is a flowchart illustrating an operation of an electronic device according to one or more embodiments.

FIG. 7 may be described with reference to FIGS. 1, 2A, or 2B.

In the following embodiment, each of operations may be sequentially performed, but are not necessarily performed sequentially. For example, an order of each of operations may be changed, and at least two operations may also be performed in parallel.

Referring to FIG. 7, in operation 710, according to one or more embodiments, an electronic device 101 may identify a user profile. The electronic device 101 may identify a user profile for an input image. The user profile for an input image may be a user profile associated with a type of the image and/or a situation in which the input image is captured. For example, a user profile DB 280 may store a plurality of user profiles distinguished from each other according to a type of an input image and/or a situation in which the input image is captured. For example, the plurality of user profiles may be divided into user profiles for landscape, portrait, or still life. For example, the plurality of user profiles may be divided into user profiles for a purpose (e.g., a background screen or a lock screen (e.g., a wallpaper), or uploading or sharing an SNS application) of an image. For example, the plurality of user profiles may be distinguished for a situation (e.g., a type (e.g., a person, an animal, a plant, or an item) of objects, a relationship (e.g., a friend or family) between the objects, and/or a time (e.g., morning, forenoon, afternoon, evening, or dawn) included in the image) in which an input image is captured (or obtained) (or describes).

In operation 720, in one or more embodiments, the electronic device 101 may process an image based on the user profile. In one or more embodiments, the electronic device 101 may identify at least one user profile corresponding to an input image among one or more user profiles stored in the user profile DB 280. In one or more embodiments, the electronic device 101 may identify at least one user profile corresponding to a type of an input image and/or a situation (hereinafter, a situation of the input image) in which the input image is obtained (or captured) (or describes) in the user profile DB 280. In one or more embodiments, the electronic device 101 may generate an image-processed output image from an input image based on the identified user profile. However, it is not limited thereto. In one or more embodiments, the electronic device 101 may generate an output image based on a user profile without an input image.

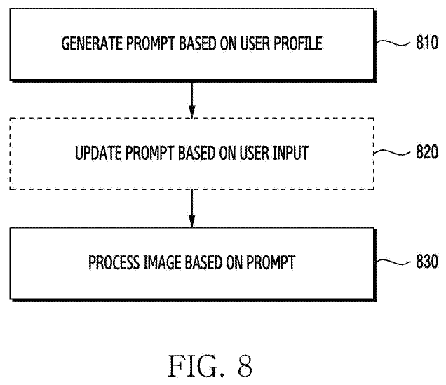

In one or more embodiments, the electronic device 101 may process an image using a prompt based on a user profile. In one or more embodiments, the prompt may be a set of words (or a sentence including words) for correcting (or processing) an input image through the generative AI module 231. Hereinafter, the operation in which the electronic device 101 processes an image using a prompt based on a user profile will be described with reference to FIG. 8.

FIG. 8 is a flowchart illustrating an operation of an electronic device according to one or more embodiments.

FIG. 8 may be described with reference to FIGS. 1, 2A, or 2B. Operations of FIG. 8 may be included in the operation 720 of FIG. 7.

In the following embodiment, each of operations may be sequentially performed, but are not necessarily performed sequentially. For example, an order of each of operations may be changed, and at least two operations may also be performed in parallel.

Referring to FIG. 8, in operation 810, in one or more embodiments, an electronic device 101 may generate a prompt based on a user profile. The electronic device 101 may generate a prompt for guiding generation of an output image through a generative AI module 231 based on the user profile. For example, the electronic device 101 may generate a prompt including at least one of words included in the user profile.

In operation 820, in one or more embodiments, the electronic device 101 may update the prompt based on a user input. In one or more embodiments, the electronic device 101 may output (or display) a prompt based on a user profile DB 280 through a display 260. In one or more embodiments, the electronic device 101 may obtain a user input for the prompt while the prompt is outputted through the display 260. In one or more embodiments, the electronic device 101 may present (or output) (or display) candidate words based on the user input to the prompt. For example, the candidate words may be words of substantially the same type (or category) as a word selected by the user input. The type (or category) of words being substantially the same may indicate that a type (or category) of image correction related to the word is substantially the same (or similar). For example, the type (or category) of image correction may be divided into an image filter, a color tone, and/or a deco. For example, in a case that two or more words are associated with an image filter, the two or more words may be evaluated as substantially the same (or similar) type (or category). For example, in a case that two or more words are associated with a color tone, the two or more words may be evaluated as substantially the same (or similar) type (or category). For example, in a case that two or more words are associated with a deco, the two or more words may be evaluated as substantially the same (or similar) type (or category). However, it is not limited thereto. For example, since two or more color tones may be applied to an image, words related to different color tones may be evaluated as having different types (or categories). For example, a word related to a light balance may be evaluated as a different type of word from a word related to brightness. In one or more embodiments, the candidate words may be words related to new features included in a new feature DB 265. In one or more embodiments, the candidate words may be selected in descending order of the number of times they are extracted from among words related to new features. However, it is not limited thereto. In one or more embodiments, the candidate words may be words related to a pre-update user profile (or a user profile before a current user profile).

In one or more embodiments, the electronic device 101 may change a prompt based on the user profile DB 280 based on the user input. In one or more embodiments, the electronic device 101 may change a prompt based on a user input for selecting a word among the candidate words. In one or more embodiments, the user input may include a touch input for at least one of the outputted (or displayed) candidate words, and/or an input through an input module 150. However, it is not limited thereto.

In operation 830, in one or more embodiments, the electronic device 101 may process an image based on the prompt. In one or more embodiments, the electronic device 101 may generate an output image by inputting the prompt to a generative AI module 231. In one or more embodiments, the electronic device 101 may generate an output image by inputting the prompt and an input image to the generative AI module 231. For example, the processing of an image may include application of an image filter (e.g., Warm, Calm, Lolly, Winter, Pink Rose, Ivory, Faded, Soft, Kiss Me, Black and White, Cinematic, Loof, Shadow, Monstera, Palm Tree, Vignetting, Blur, and/or Bokeh) to the image. In one or more embodiments, the processing of an image may include adjustment of a color tone (e.g., a light balance, brightness, exposure, contrast, highlight, shadow, saturation, tint, color temperature, sharpness, and/or clarity) of the image. In one or more embodiments, the processing of an image may include application of a deco (e.g., drawing, a sticker, and/or a text) of the image.

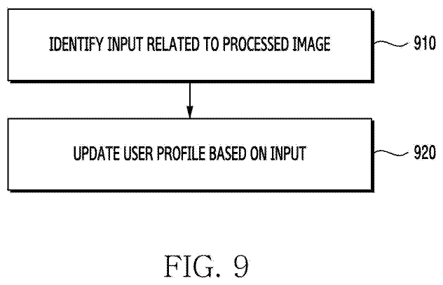

FIG. 9 is a flowchart illustrating an operation of an electronic device according to one or more embodiments.

FIG. 9 may be described with reference to FIGS. 1, 2A, or 2B. Operations of FIG. 9 may be performed after the operation 720 of FIG. 7 or after the operation 830 of FIG. 8.

In the following embodiment, each of operations may be sequentially performed, but are not necessarily performed sequentially. For example, an order of each of operations may be changed, and at least two operations may also be performed in parallel.

Referring to FIG. 9, in operation 910, in one or more embodiments, an electronic device 101 may identify an input related to a processed image. For example, the input related to a processed image may include a user input for changing a prompt inputted to a generative AI module 231. For example, the input related to a processed image may include a user input related to feedback on an output image outputted by the generative AI module 231.

In operation 920, in one or more embodiments, the electronic device 101 may update a user profile based on the input. For example, in a case that a prompt is changed based on the input, the electronic device 101 may update the user profile based on the changed prompt. For example, in a case that feedback (or positive feedback) on an output image is obtained based on the input, the electronic device 101 may update the user profile based on the output image.

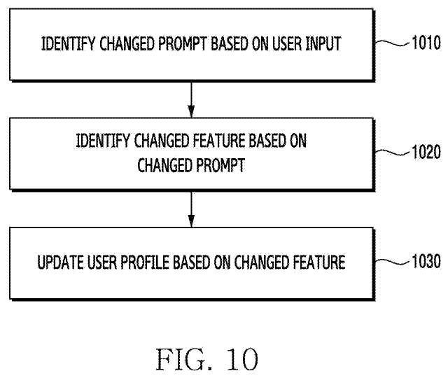

For example, the electronic device 101 may extract one or more features from the changed prompt. For example, the electronic device 101 may update the user profile based on the one or more features extracted from the changed prompt. Hereinafter, the operation in which the electronic device 101 updates the user profile based on the one or more features extracted from the changed prompt will be described with reference to FIG. 10.

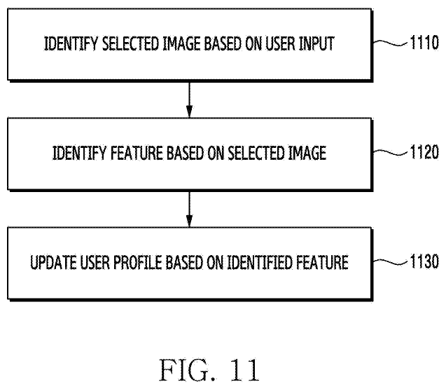

For example, the electronic device 101 may extract one or more features from an output image. For example, the electronic device 101 may update the user profile based on the one or more features extracted from an output image. Hereinafter, the operation in which the electronic device 101 updates the user profile based on the one or more features extracted from an output image will be described with reference to FIG. 11.

FIG. 10 is a flowchart illustrating an operation of an electronic device according to one or more embodiments.

FIG. 10 may be described with reference to FIGS. 1, 2A, or 2B. Operations of FIG. 10 may be included in the operation 920 of FIG. 9.

In the following embodiment, each of operations may be sequentially performed, but are not necessarily performed sequentially. For example, an order of each of operations may be changed, and at least two operations may also be performed in parallel.

Referring to FIG. 10, in operation 1010, in one or more embodiments, an electronic device 101 may identify a changed prompt based on a user input. For example, the change in a prompt may include that a prompt generated by a prompt management module 220 is changed by a user input. For example, the user input may be an input for changing a prompt “Apply a clear and vivid image filter” to a prompt “Apply a warm retro image filter”. For example, the user input may be an input for changing a prompt “Apply a pinkish tint image filter with a blurred feel” to a prompt “Apply a clear and natural image filter”. For example, the user input may be an input for changing a prompt “Apply an A character sticker” to a prompt “Apply a C character sticker”.

In operation 1020, in one or more embodiments, the electronic device 101 may identify a changed feature based on the changed prompt. For example, in a case that the prompt “Apply a clear and vivid image filter” is changed to the prompt “Apply a warm retro image filter”, the electronic device 101 may identify a changed feature (e.g., changed words (change from clear and to warm, or change from vivid to retro)). For example, in a case that the prompt “Apply a pinkish tint image filter with a blurred feel” is changed to the prompt “Apply a clear and natural image filter”, the electronic device 101 may identify a changed feature (e.g., changed words (change from blurred feel to clear and, or change from pinkish tint to natural)). For example, in a case that the prompt “Apply an A character sticker” is changed to the prompt “Apply a C character sticker”, the electronic device 101 may identify a changed feature (e.g., changed words (change from A character sticker to C character sticker)).

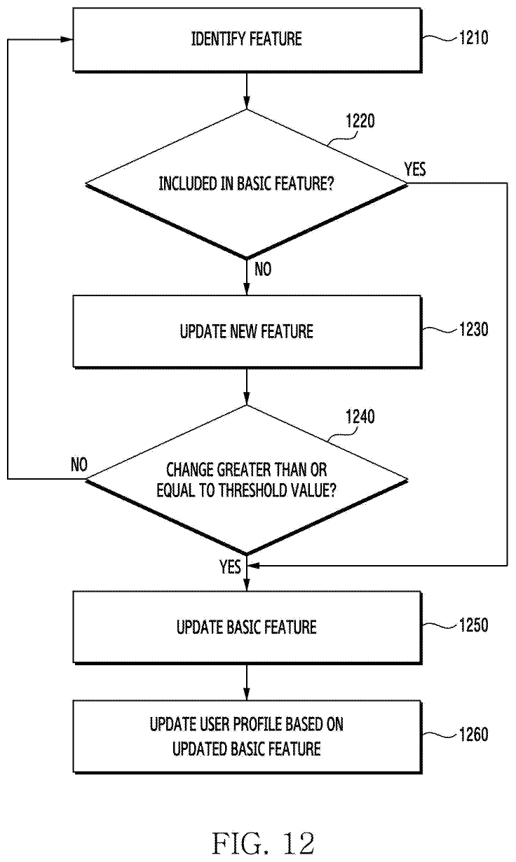

In operation 1030, in one or more embodiments, the electronic device 101 may update a user profile based on the changed feature. Hereinafter, the operation in which the electronic device 101 updates the user profile based on the changed feature will be described with reference to FIG. 12.

FIG. 11 is a flowchart illustrating an operation of an electronic device according to one or more embodiments.

FIG. 11 may be described with reference to FIGS. 1, 2A, or 2B. Operations of FIG. 11 may be included in the operation 920 of FIG. 9.

In the following embodiment, each of operations may be sequentially performed, but are not necessarily performed sequentially. For example, an order of each of operations may be changed, and at least two operations may also be performed in parallel.

Referring to FIG. 11, in operation 1110, in one or more embodiments, an electronic device 101 may identify a selected image based on a user input. For example, the electronic device 101 may identify at least one output image selected by a user input among output images outputted through a generative AI module 231.

In operation 1120, in one or more embodiments, the electronic device 101 may identify a feature based on the selected image. For example, the electronic device 101 may identify a feature indicating image processing applied to the selected image. For example, in a case that an image filter is applied to an output image, the electronic device 101 may identify (or extract) features related to the applied image filter (e.g., a word describing a type of the image filter). For example, in a case that a specific color tone is applied to an output image, the electronic device 101 may identify (or extract) features related to the applied specific color tone (e.g., a word describing the color tone). For example, in a case that a specific deco is applied to an output image, the electronic device 101 may identify (or extract) features related to the applied specific deco (e.g., a word describing the deco). For example, in a case that an output image is used as a wallpaper, the electronic device 101 may identify (or extract) features related to a pattern design, an illustration, and a description method (e.g., a person or a landscape) of the output image. For example, in a case that a character is included in an output image, the electronic device 101 may identify (or extract) features related to the character (e.g., a word (e.g., cute or funny) describing a shape of the character, and/or a type (e.g., a rabbit) of the character).

In operation 1130, in one or more embodiments, the electronic device 101 may update a user profile based on the identified feature. Hereinafter, the operation in which the electronic device 101 updates the user profile based on the identified feature will be described with reference to FIG. 12.

FIG. 12 is a flowchart illustrating an operation of an electronic device according to one or more embodiments.

FIG. 12 may be described with reference to FIGS. 1, 2A, or 2B. Operations of FIG. 12 may be included in the operation 920 of FIG. 9.

In the following embodiment, each of operations may be sequentially performed, but are not necessarily performed sequentially. For example, an order of each of operations may be changed, and at least two operations may also be performed in parallel.

Referring to FIG. 12, in operation 1210, in one or more embodiments, an electronic device 101 may identify a feature. In one or more embodiments, the feature may be a feature representing words changed by a user input. For example, the feature may be a feature representing image processing applied to an output image. However, it is not limited thereto. For example, the feature may indicate a type and/or a situation of an output image.

In operation 1220, in one or more embodiments, the electronic device 101 may determine whether the identified feature is included in a basic feature. For example, the electronic device 101 may determine whether the identified feature is a feature included in a basic feature DB 263.

In the operation 1220, in one or more embodiments, based on determining that the identified feature is included in the basic feature, the electronic device 101 may perform operation 1250. In the operation 1220, based on determining that the identified feature is not included in the basic feature, the electronic device 101 may perform operation 1230.

In operation 1230, in one or more embodiments, the electronic device 101 may update a new feature. In one or more embodiments, the electronic device 101 may store the identified feature in a new feature DB 265. In one or more embodiments, the electronic device 101 may increase the number of times of identification (or the number of times of extraction) of the identified feature stored in the new feature DB 265.

In operation 1240, in one or more embodiments, the electronic device 101 may determine whether there is a change greater than or equal to a threshold value. In one or more embodiments, the electronic device 101 may determine whether the number of times of identification of the identified feature stored in the new feature DB 265 has been changed to be greater than or equal to a threshold value.

In one or more embodiments, in the operation 1240, based on determining that the number of times of identification of the identified feature is greater than or equal to a threshold value, the electronic device 101 may perform the operation 1250. In one or more embodiments, in the operation 1240, based on determining that the number of times of identification of the identified feature is less than a threshold value, the electronic device 101 may perform the operation 1210 again. For example, based on determining that the number of times of identification of the identified feature is less than a threshold value, the electronic device 101 may perform the operations according to FIG. 12 again for another feature. However, it is not limited thereto. For example, based on determining that the number of times of identification of the identified feature is less than a threshold value, the electronic device 101 may terminate the operations according to FIG. 12.

In the operation 1250, in one or more embodiments, the electronic device 101 may update the basic feature. In one or more embodiments, the electronic device 101 may store the identified feature in the basic feature DB 263. In one or more embodiments, the electronic device 101 may change a storage location of a feature of substantially the same (or similar) type as a type of the identified feature whose storage location is changed from the new feature DB 265 to the basic feature DB 263, from the basic feature DB 263 to the new feature DB 265, based on the identified feature stored in the new feature DB 265 being stored in the basic feature DB 263.

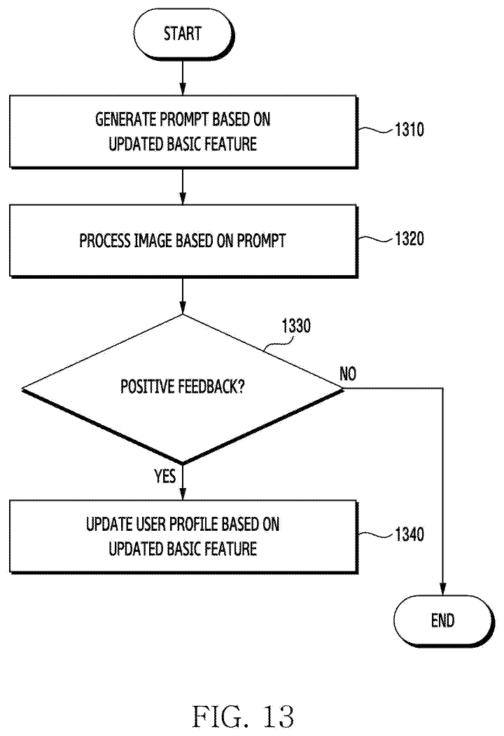

In operation 1260, in one or more embodiments, the electronic device 101 may update a user profile based on the updated feature. Hereinafter, the operation in which the electronic device 101 updates the user profile based on the updated feature will be described with reference to FIG. 13.

FIG. 13 is a flowchart illustrating an operation of an electronic device according to one or more embodiments.

FIG. 13 may be described with reference to FIGS. 1, 2A, or 2B. Operations of FIG. 13 may be included in the operation 1260 of FIG. 12.

In the following embodiment, each of operations may be sequentially performed, but are not necessarily performed sequentially. For example, an order of each of operations may be changed, and at least two operations may also be performed in parallel.

Referring to FIG. 13, in operation 1310, in one or more embodiments, an electronic device 101 may generate a prompt based on an updated feature. The electronic device 101 may generate a prompt based on the updated feature in response to an additional user input requesting image processing. For example, the electronic device 101 may generate a prompt including the updated feature among features stored in a basic feature DB 263. For example, the electronic device 101 may generate a prompt including the updated feature among features stored in a new feature DB 265. For example, the electronic device 101 may generate a prompt by combining the features stored in the basic feature DB 263 and/or the features stored in the new feature DB 265. For example, some of the features included in the prompt may be the updated feature.

In operation 1320, in one or more embodiments, the electronic device 101 may process an image based on the prompt. In one or more embodiments, the electronic device 101 may generate an output image by inputting the prompt to a generative AI module 231. For example, processing of an image may include application of an image filter to the image. In one or more embodiments, the processing of an image may include adjustment of a color tone of the image. In one or more embodiments, the processing of an image may include application of a deco of the image.

In operation 1330, in one or more embodiments, the electronic device 101 may determine whether positive feedback exists. For example, in a case that saving, uploading, sharing, or favorite (or, like) of an image generated through the prompt based on the updated feature occurs, the electronic device 101 may determine that positive feedback exists. For example, in a case that a request for deletion or modification of an image generated through the prompt based on the updated feature occurs, the electronic device 101 may determine that negative feedback exists.

In one or more embodiments, in the operation 1330, based on determining that positive feedback exists, the electronic device 101 may perform operation 1340. In one or more embodiments, in the operation 1330, based on determining that positive feedback does not exist (or negative feedback exists), the electronic device 101 may terminate the operations according to FIG. 13.

In the operation 1340, in one or more embodiments, the electronic device 101 may update a user profile based on the updated feature. For example, the electronic device 101 may update a user profile for correction of an image having substantially the same type and/or situation as an output image. Thereafter, a prompt in which positive feedback exists may be generated through the updated user profile.

FIG. 14 is a diagram illustrating a structure of a generative AI model of an electronic device, according to one or more embodiments.

FIG. 14 may be described with reference to FIGS. 1, 2A, or 2B.

In one or more embodiments, a user interface (UI) 1410 may be an element for interaction between an electronic device 101 and a user. For example, the UI 1410 may be an element for receiving (or obtaining) an input of the user. For example, the UI 1410 may be an element for providing (or outputting) a result of an input of the user.

In one or more embodiments, the UI 1410 may be a graphic UI (GUI) for interaction (e.g., obtaining of a touch input and/or display of a result) with a user through a display 260. In one or more embodiments, the UI 1410 may be a voice UI (VUI) (or an auditory UI (AUI)) for interaction (e.g., obtaining of a voice signal and/or output of an audio signal) with a user through a sound output module 155 (or an audio module 170). In one or more embodiments, the UI 1410 may be a natural UI (NUI) for interaction (e.g., obtaining of a gesture or a gaze of the user) with a user through a camera module 180. In one or more embodiments, the UI 1410 may be a physical UI (PUI) (or a tangible UI (TUI)) for interaction (e.g., an input to a physical button) with a user through an input module 150.

In one or more embodiments, the UI 1410 may be a configuration for interaction between the electronic device 101 and the user for a query of the user and/or a response to the query. In one or more embodiments, the UI 1410 may receive an input of the user. For example, the input of the user may include a natural language input (e.g., a voice signal input, and/or a text input), and/or an input selecting (or indicating) content (e.g., an image and/or a video). In addition, the user input may also be in a form in which the above-described natural language, image, sound, and context information are mixed. In addition, the user input may also be in an unnatural form such as selecting a menu.

In one or more embodiments, the UI 1410 may identify (or obtain) information on a context related to a time point (or a situation) at which an input of the user is obtained for a query of the user and/or a response to the query. In one or more embodiments, the information on the context may include additional information at the time of the user input. For example, the additional information may include information on an application currently used by the user or location information of the user (or the electronic device 101).

In one or more embodiments, the electronic device 101 may output a result of a generative AI model 1450 to the user through the UI 1410. In one or more embodiments, the output may have a natural language form or a specific content form. In one or more embodiments, the output may be provided in a form (e.g., an action) requested by the user.

In one or more embodiments, the UI 1410 may transmit information on the input of the user and/or the context to an artificial intelligence (AI) framework 1420. In one or more embodiments, the AI framework 1420 may obtain information on the input of the user and/or the context from the UI 1410.

In one or more embodiments, the AI framework 1420 may coordinate and/or control each of components (e.g., an interface management element 1421, a prompt design element 1423, or an output modification element 1425) necessary to perform an operation according to an intention of the user identified based on a query of the user (or a query included in the user input).

In one or more embodiments, the AI framework 1420 may transmit the input of the user obtained from the UI 1410 to the prompt design element 1423.

In one or more embodiments, the prompt design element 1423 may generate a prompt suitable for inputting the user input to the generative AI model 1450 (e.g., a large language model (LLM) and/or a larger multimodal model (LMM)).

In one or more embodiments, the prompt design element 1423 may be an AI component using a machine learning algorithm or a neural network. Accordingly, in the prompt design element 1423, the generated prompt may be changed by learning.

In one or more embodiments, the prompt design element 1423 may generate a prompt by accessing a knowledge element (or a knowledge archive 1430) including user preference data, a prompt library, and a prompt example based on a user input, and may transmit the generated prompt to the generative AI model 1450 (e.g., the LLM and/or the LMM).

In one or more embodiments, the interface management element 1421 may communicate with an external element. In one or more embodiments, the interface management element 1421 may obtain additional information from an external element in a case that there is a request for the additional information when transmitting a user input (or a prompt based on the user input) to an input of the generative AI model 1450. In one or more embodiments, the interface management element 1421 may establish a channel that may communicate with the outside of the AI framework 1420 through an application programming interface (API), and enable the AI framework 1420 to access various data sources (e.g., the knowledge archive 1430) through the established channel. In addition, the interface management element 1421 may request an action to a service element 1440 through the API in a case that an application and/or a service should perform the action of ultimately performing an input of the user other than an intermediate result. The information obtained from an external element may be used to generate a prompt in the prompt design element 1423 together with a user input or may also be transmitted as an input of the generative AI model 1450.

In one or more embodiments, the output modification element 1425 may fine tune a result outputted from the generative AI model 1450. For example, the output modification element 1425 may verify (e.g., verify relevance, bias, and/or harmfulness) content generated through the generative AI model 1450 (e.g., the LLM and/or the LMM). In addition, the output modification element 1425 may determine how much the output result matches a desired result of the user and proceed with an additional task for an additional adjustment, if, in a case that the additional adjustment is needed. Additionally, the output modification element 1425 may provide the user with a hint for preventing (or reducing) an undesired output.

In one or more embodiments, in general, the generative AI model 1450 may refer to an artificial intelligence neural network that generates a new type of data depending on user input information. The generative AI model 1450 may include a model for generating an image and/or a model for generating a language. The model generating an image may include a generative adversarial network (GAN), a variational auto encoder (VAE), and/or a diffusion-based generative model that uses the VAE and a transformer structure. The model generating a language may be a model trained to output the most statistically appropriate output value based on an input value. For example, the model generating a language may include a model such as CHAT-GPT 3 or CHAT-GPT 4. In addition, the generative AI model 1450 may be an LMM capable of recognizing various types of data inputs such as a message, an image, and a voice and generating new data corresponding thereto.

An electronic device 101 as described above may include at least one processor 120 including processing circuitry. The electronic device 101 may include memory 130 including one or more storage mediums storing instructions. The instructions, when executed by the at least one processor 120 individually or collectively, may cause the electronic device 101 to, based on a user profile, generate a prompt 330 or 335 for processing an image 341. The instructions, when executed by the at least one processor 120 individually or collectively, may cause the electronic device 101 to, based on the prompt 330 or 335, control a generative artificial intelligence (AI) model 231 to process the image 341. The instructions, when executed by the at least one processor 120 individually or collectively, may cause the electronic device 101 to, based on a user input related to the processed image 343 or 345, determine whether to update the user profile.

The instructions, when executed by the at least one processor 120 individually or collectively, may cause the electronic device 101 to obtain the user input 350 for changing the prompt 330. The instructions, when executed by the at least one processor 120 individually or collectively, may cause the electronic device 101 to, based on the prompt 335 changed based on the user input 350, control the generative AI model 231 to process the image 341.

The instructions, when executed by the at least one processor 120 individually or collectively, may cause the electronic device 101 to identify at least one word distinct from words for a common feature among one or more words included in the prompt 335. The instructions, when executed by the at least one processor 120 individually or collectively, may cause the electronic device 101 to, based on the number of times the at least one word is inputted as a prompt to the generative AI model 231, determine whether to update the user profile.

The instructions, when executed by the at least one processor 120 individually or collectively, may cause the electronic device 101 to obtain the user input for selecting the processed image 345. The instructions, when executed by the at least one processor 120 individually or collectively, may cause the electronic device 101 to identify one or more words describing the processed image 345 selected based on the user input. The instructions, when executed by the at least one processor 120 individually or collectively, may cause the electronic device 101 to identify at least one word distinct from words for a common feature among the one or more words. The instructions, when executed by the at least one processor 120 individually or collectively, may cause the electronic device 101 to, based on the number of times the at least one word is identified as a word describing the processed image 345 processed through the generative AI model 231, determine whether to update the user profile.

One or more words included in the prompt 330 or 335 may include one or more first words for a common feature and one or more second words for a new feature. The first words and the second words may be words included in categories different from each other.

The electronic device 101 as described above may include a display 260. The instructions, when executed by the at least one processor 120 individually or collectively, may cause the electronic device 101 to display, through the display 260, the prompt 330. The instructions, when executed by the at least one processor 120 individually or collectively, may cause the electronic device 101 to obtain the user input 350 for changing a word among one or more words included in the prompt 330. The instructions, when executed by the at least one processor 120 individually or collectively, may cause the electronic device 101 to, based on the user input 350, change the prompt 330.

The instructions, when executed by the at least one processor 120 individually or collectively, may cause the electronic device 101 to display, through the display 260, a menu 303 or 305 including a plurality of candidate words replaceable from the word 310 or 320 indicated by the user input.

The plurality of candidate words may include words related to new features selected upon change of a prompt by another user input and/or words related to previous basic features. The word 310 or 320 and the plurality of candidate words may be included in a same category. The words related to the new features and the words related to the previous basic features are expressed differently from each other when displayed through the display 260.

The instructions, when executed by the at least one processor 120 individually or collectively, may cause the electronic device 101 to, based on the user profile being changed, re-process an image 453, processed based on the user profile before the change, based on the user profile after the change.

The instructions, when executed by the at least one processor 120 individually or collectively, may cause the electronic device 101 to, based on the user profile being changed, re-process an image, processed based on the user profile after the change, based on the user profile before the change.

A method as described above may be performed by an electronic device 101. The method may include, based on a user profile, generating a prompt 330 or 335 for processing an image 341. The method may include, based on the prompt 330 or 335, controlling a generative artificial intelligence (AI) model 231 to process the image 341. The method may include, based on a user input related to the processed image 343 or 345, determining whether to update the user profile.

The method may include obtaining the user input 350 for changing the prompt 330. The method may include, based on the prompt 335 changed based on the user input 350, controlling the generative AI model 231 to process the image 341.

The method may include identifying at least one word distinct from words for a common feature among one or more words included in the prompt 330. The method may include, based on the number of times the at least one word is inputted as a prompt 330 to the generative AI model 231, determining whether to update the user profile.

The method may include obtaining the user input for selecting the processed image 345 The method may include identifying one or more words describing the processed image 345 selected based on the user input. The method may include identifying at least one word distinct from words for a common feature among the one or more words. The method may include, based on the number of times the at least one word is identified as a word describing the processed image 345 processed through the generative AI model 231, determining whether to update the user profile.

One or more words included in the prompt 330 or 335 may include one or more first words for a common feature and one or more second words for a new feature. The first words and the second words may be words included in categories different from each other.

The method may include displaying, through the display 260, the prompt 330. The method may include obtaining the user input for changing a word among one or more words included in the prompt 330. The method may include, based on the user input, changing the prompt 330.

The method may include displaying, through the display 260, a menu 303 or 305 including a plurality of candidate words replaceable from the word 310 or 320 indicated by the user input.

The plurality of candidate words may include words related to new features selected upon change of a prompt by another user input and/or words related to previous basic features. The word 310 or 320 and the plurality of candidate words may be included in a same category. The words related to the new features and the words related to the previous basic features may be expressed differently from each other when displayed through the display 260.

The method may include, based on the user profile being changed, re-processing an image 453, processed based on the user profile before the change, based on the user profile after the change.

The method may include, based on the user profile being changed, re-processing an image 341, processed based on the user profile after the change, based on the user profile before the change.

A non-transitory computer readable storage medium as described above may store a program including instructions. An electronic device 101 may include at least one processor 120 including processing circuitry. The electronic device 101 may include memory 130 including one or more storage mediums storing instructions. The instructions, when executed individually or collectively by the at least one processor 120 including processing circuitry of the electronic device 101, may cause the electronic device 101 to, based on a user profile, generate a prompt 330 or 335 for processing an image 341. The instructions, when executed by the at least one processor 120 individually or collectively, may cause the electronic device 101 to, based on the prompt 330 or 335, control a generative artificial intelligence (AI) model 231 to process the image 341. The instructions, when executed by the at least one processor 120 individually or collectively, may cause the electronic device 101 to, based on a user input related to the processed image 343 or 345, determine whether to update the user profile.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to one or more embodiments of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to one or more embodiments, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to one or more embodiments, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
at least one processor comprising processing circuitry; and
memory comprising one or more storage mediums storing instructions,
wherein the instructions, when executed by the at least one processor individually or collectively, cause the electronic device to:
generate, based on a user profile, a prompt for processing an image;
control, based on the prompt, a generative artificial intelligence (AI) model to process the image; and
determine, based on a user input related to the processed image, whether to update the user profile.

2. The electronic device of claim 1, wherein the instructions, when executed by the at least one processor individually or collectively, cause the electronic device to:
obtain the user input for changing the prompt;
change the prompt based on the user input for changing the prompt; and
control, based on the changed prompt, the generative AI model to process the image.

3. The electronic device of claim 2, wherein the instructions, when executed by the at least one processor individually or collectively, cause the electronic device to:
identify at least one word distinct from words for a common feature among one or more words included in the prompt; and
determine whether to update the user profile, based on a number of times the at least one word is inputted as a prompt to the generative AI model.

4. The electronic device of claim 1, wherein the instructions, when executed by the at least one processor individually or collectively, cause the electronic device to:
obtain the user input for selecting the processed image;
identify one or more words describing the processed image selected based on the user input for selecting the processed image;
identify at least one word distinct from words for a common feature among the one or more words; and
determine whether to update the user profile based on a number of times the at least one word is identified as a word describing the processed image processed through the generative AI model.

5. The electronic device of claim 1, wherein one or more words included in the prompt comprise one or more first words for a common feature and one or more second words for a new feature, and
wherein the first words and the second words are words associated with categories that are different from each other.

6. The electronic device of claim 1, comprising:
a display,
wherein the instructions, when executed by the at least one processor individually or collectively, cause the electronic device to:
display, via the display, the prompt;
obtain the user input for changing a word among one or more words included in the prompt; and
change the prompt based on the user input for changing the word.

7. The electronic device of claim 6, wherein the instructions, when executed by the at least one processor individually or collectively, cause the electronic device to:
display, through the display, a menu including a plurality of candidate words replaceable from the word indicated by the user input for changing the word.

8. The electronic device of claim 7, wherein the plurality of candidate words comprise words related to new features selected upon change of a prompt by another user input and/or words related to previous basic features,
wherein the word and the plurality of candidate words are associated with a same category, and
wherein the words related to the new features and the words related to the previous basic features are expressed differently from each other when displayed through the display.

9. The electronic device of claim 1, wherein the instructions, when executed by the at least one processor individually or collectively, cause the electronic device to:
based on the user profile being changed, re-process an image based on the user profile after the change, wherein the image was processed based on the user profile before the change.

10. The electronic device of claim 1, wherein the instructions, when executed by the at least one processor individually or collectively, cause the electronic device to:
based on the user profile being changed, re-process an image based on the user profile before the change, wherein the image was processed based on the user profile after the change.

11. A method performed by an electronic device, the method comprising:
generating, based on a user profile, a prompt for processing an image;
controlling, based on the prompt, a generative artificial intelligence (AI) model to process the image; and
determining, based on a user input related to the processed image, whether to update the user profile.

12. The method of claim 11, comprising:
obtaining the user input for changing the prompt;
changing the prompt based on the user input for changing the prompt; and
based on the changed prompt, controlling the generative AI model to process the image.

13. The method of claim 12, comprising:
identifying at least one word distinct from words for a common feature among one or more words included in the prompt; and
determining whether to update the user profile based on a number of times the at least one word is inputted as a prompt to the generative AI model.

14. The method of claim 11, comprising:
obtaining the user input for selecting the processed image;
identifying one or more words describing the processed image selected based on the user input for selecting the processed image;
identifying at least one word distinct from words for a common feature among the one or more words; and
determining whether to update the user profile based on a number of times the at least one word is identified as a word describing the processed image processed through the generative AI model.

15. The method of claim 11, wherein one or more words included in the prompt comprise one or more first words for a common feature and one or more second words for a new feature, and
wherein the first words and the second words are words associated with categories different from each other.

16. The method of claim 11, further comprising:
displaying, via a display of the electronic device, the prompt;
obtaining the user input for changing a word among one or more words included in the prompt; and
changing the prompt based on the user input for changing the word.

17. The method of claim 16, comprising:
displaying, through the display, a menu including a plurality of candidate words replaceable from the word indicated by the user input for changing the word.

18. The method of claim 17, wherein the plurality of candidate words comprise words related to new features selected upon change of a prompt by another user input and/or words related to previous basic features,
wherein the word and the plurality of candidate words are associated with a same category, and
wherein the words related to the new features and the words related to the previous basic features are expressed differently from each other when displayed through the display.

19. The method of claim 11, comprising:
based on the user profile being changed, re-processing an image based on the user profile after the change, wherein the image was processed based on the user profile before the change.

20. The method of claim 11, comprising:
based on the user profile being changed, re-processing an image based on the user profile before the change, wherein the image was processed based on the user profile after the change.
